(19) United States
(12) Patent Application Publication
(10) Pub. No.: US 2011/0246603 A1
(43) Pub. Date: Oct. 6, 2011

(54) METHODS AND DEVICES FOR LIVE STREAMING USING PRE-INDEXED FILE FORMATS

(75) Inventor: Yiubun Lee, Kowloon City (CN)

(73) Assignee: The Chinese University of Hong Kong, Hong Kong (CN)

(21) Appl. No.: 13/061,925

(22) PCT Filed: Sep. 4, 2009
(86) PCT No.: PCT/CN09/73766

§ 371 Date: May 2, 2011

Related U.S. Application Data
(60) Provisional application No. 61/094,698, filed on Sep. 5, 2008.

(51) Int. Cl. G06F 15/16

(52) U.S. Cl. 709/217

(57) ABSTRACT

Provided are methods and devices for live streaming a plurality of media data units using a media file format. The method may comprise the steps of pre-generating indexing information of each of the media data units; encoding each of the media data units; transmitting the pre-generated indexing information to a receiver; and transmitting a sequence of the encoded media data units to the receiver after the transmission of the indexing information.

### TECHNICAL FIELD

The present application relates to media streaming, in particular, to live streaming using pre-indexed media file formats.

### BACKGROUND

Multimedia files such as audio and video files are often compressed or encoded to reduce storage sizes and transmission bandwidths. The compressed or encoded multimedia files need to be stored in a certain form of file structure so that media data units in the files may be retrieved and then decoded. Typically, a general media file includes a series of individual media data units to be playback sequentially, as well as indexing information such as size, timing, and location of individual media data units for facilitating access to the file.

There are many types of multimedia file structures in use today which are generally classified into two types: pre-indexed and post-indexed. A pre-indexed file typically contains a separate section where the indexing information for all media data units is stored. For a post-indexed file, the indexing information for each media data unit is either stored alongside the data unit, i.e., in a distributed manner, or to be determined from the data unit. A sequence in which individual media data units to be played back is usually determined either by information contained in the media data units or determined by the indexing information or other information contained in the file or a combination thereof. For example, a video file may comprise a plurality of media data units and each individual media data unit may be a video frame. In this case, the video frames may be played back in sequence according to the indexing information at a frame rate determined during encoding and recorded in the video file. In more complex scenarios, the video frames may not even be played back at a fixed frame rate but at precise time instants prescribed for each individual frames.

However, the pre-indexed file structure requires the indexing information of the entire file to be computed and stored before the file can be used for decoding and thus cannot be used in applications for live streaming media contents. In conventional means for creating a pre-indexed media file, each of the media data units is encoded and then the indexing information of corresponding unit is computed. After all units are encoded and all indexing information for all units is obtained, all the encoded units and all the indexing information are organized as a pre-indexed media file, wherein all the indexing information is collected as a part of the media file. Two possible arrangements of a pre-indexed media file are illustrated in FIG. 1. In both cases, all indexing information is stored in a section separated from the media data units, either before or after the media data units. More generally, the stored indexing information may be located at different location of the media file depending on the particular media format used. The stored indexing information may also be broken down into multiple portions and stored separately in the file, again depending on the particular media format used. Since all media data units have to be encoded and their indexing information has to be computed before the media file can be finally created, this process prevents the use of pre-indexed media files in live streaming applications.

In live streaming applications, it is necessary to encode, distribute, and playback media data units in a pipeline so that the time delay from encoding to playback can be reduced. Taking live streaming a 1-hour video show as an example, if a pre-indexed media file is to be used for such an application, the system will need to first encode the entire 1-hour video show before the indexing information can be generated and stored into the media file, after which the file can then be used for playback, either via some form of shared storage or via transmission over a network to the receiver. In any case, playback of the media file will necessarily experience a delay of at least 1 hour comparing to the original video show. Clearly, this is a major problem in applications where such delays are undesirable or unacceptable, such as live soccer games, live TV news, radio, interactive video applications, and so on.

### SUMMARY

In one aspect of the present application, a method for live streaming a plurality of media data units using a pre-indexed media file format is provided. The method comprises pre-generating indexing information of each of the media data units; encoding each of the media data units; transmitting the pre-generated indexing information to a receiver; and transmitting a sequence of the encoded media data units to the receiver after the transmission of the indexing information.

In another aspect of the present application, a method for live streaming a plurality of media data units using a pre-indexed media file format to a plurality of receivers is provide. The method comprises pre-generating a set of indexing information for each of the receivers, respectively, each set of indexing information including indexing information of each of the media data units; encoding each of the media data units; transmitting a corresponding set of indexing information to each of the receivers; and transmitting a sequence of the encoded media data units to each of the receivers after the transmission of the indexing information.

In a further aspect of the present application, a device for live streaming a plurality of media data units using a pre-indexed media file format is provided. The device comprises a calculating unit configured to calculate indexing information of each of the media data units; an encoding unit configured to encode each of the media data units; and a transmitting unit configured to transmit the calculated indexing information for all the media data units to a receiver and to transmit a sequence of the encoded media data units to the receiver after the transmission of the indexing information.

In a yet another aspect of the present application, a method for generating a pre-indexed media file is provided. The media file includes a plurality of media data units. The method comprises pre-generating indexing information of each of the media data units; encoding each of the media data units; storing the pre-generated indexing information of all the media data units; and storing a sequence of the encoded media data units following the stored indexing information.

### BRIEF DESCRIPTION OF THE DRAWINGS

FIG. 1 illustrates the structure of pre-indexed media files;

FIG. 2 illustrates a flow chart of the method for generating a pre-indexed media file according to the present application;

FIG. 3 shows an illustrative transmission of a pre-indexed media file according to the present application;

FIG. 4 illustrates a flow chart of the method for live streaming using a pre-indexed media file format according to the present application;

FIG. 5 shows the independent Indexing information Pre-Generation and media encoding;

FIG. 6 shows cascaded Indexing information Pre-Generation and media encoding; and

FIG. 7 shows an illustrative block view of a device for live streaming using a pre-indexed media file format according to the present application.

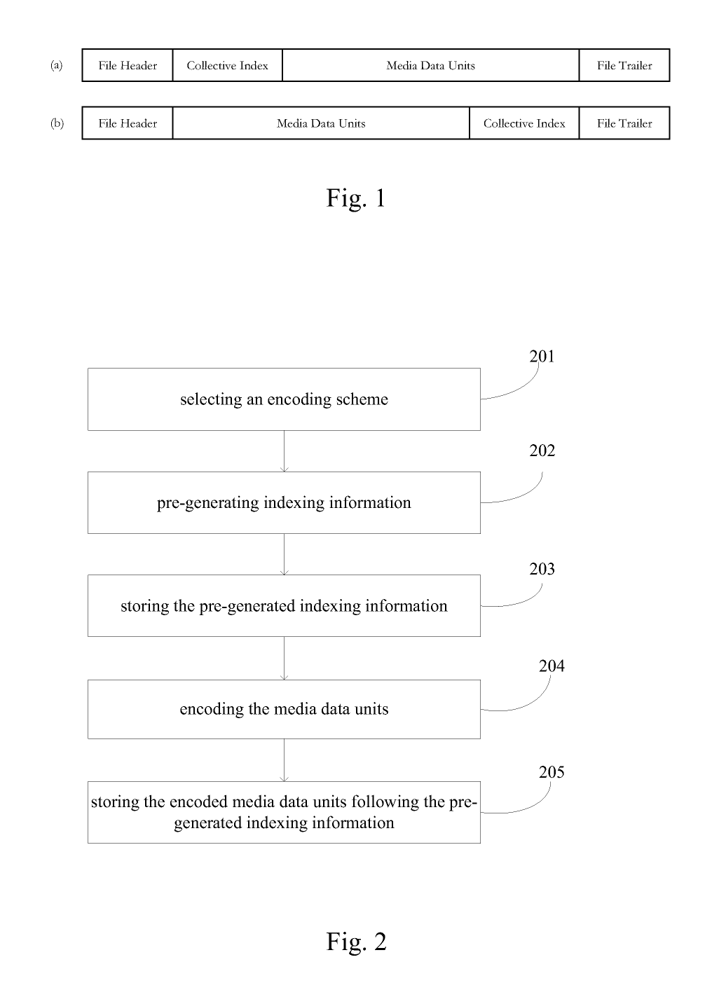

### DETAILED DESCRIPTION

In the context of the present application, the use of the term “indexing information” is general and may include, depending on the particular multimedia file format, a wide variety of information, such as size, location, duration, decoding time, playback time, and any other information of the individual media data units in a file, so that playback software/hardware may locate and retrieve required media data units for decoding and playback. Generally, the media data units are not necessarily stored or included in the media file according to playback sequence, and the playback software/hardware may also playback arbitrary parts of the media data units in any order. Thus, the availability of the indexing information enables these random accesses and playback of the media data units.

As discussed above, a pre-indexed media file generated by conventional means cannot be used until all the media data units are encoded, thus introducing delays in playback. To solve this problem, the present application proposes a method for generating a pre-indexed media file which can be used for live steaming, and a method for live streaming using a pre-indexed media file formats.

### Generating a Pre-Indexed Media File

Referring to FIG. 2, an illustrated chart flow of the method for generating a pre-indexed media file which can be used for live streaming according to an embodiment of the present application is shown. At step 201, an encoding scheme is selected for a media file. The encoding scheme may be selected based on pre-determined configuration, dynamically determined configuration, of which the exact method is application dependent. When the encoding scheme is selected, encoding parameters and an encoder profile are determined. The encoding parameters may comprise at least a frame rate and a bit-rate to be used for encoding. The encoder profile may specify an encoder-specific rule to be applied, such as an encoder pattern of intra-coded frames (I-frames), predicted frames (P-frames) and bi-predictive frames (B-frames). In one example, only I-frames are involved in the encoder. Alternatively, both I-frames and P-frames may be contained in the encoder according to a certain arrangement. Alternatively, I-frames, P-frames and B-frames may be contained in the encoder according to a certain arrangement.

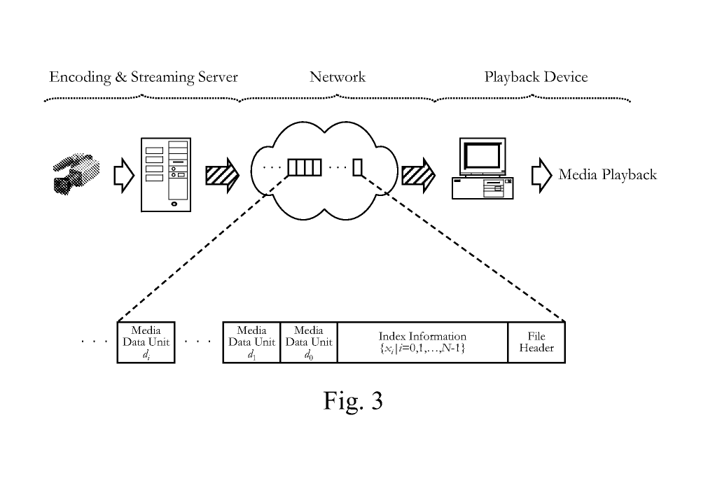

At step 202, indexing information for all raw media data units contained in a raw media file is pre-generated based on the determined encoding parameters and encoder profile. At step 203, the pre-generated indexing information for all the raw media data units is stored, for example, following a file header for the media file, in a shared storage such as a shared disk storage or a shared memory buffer. After all the indexing information is generated, raw media data units contained in the media file are encoded, for example sequentially, at step 204 according to the selected encoding scheme. The encoded units are stored following the pre-generated indexing information at step 205. Accordingly, a pre-indexed media file as shown in FIG. 3 may be obtained. Optionally, a step for adjusting the encoded media data unit to match the pre-generated indexing information may be further comprised between the steps 204 and 205, so that each of the encoded media data units precisely matches the pre-generated indexing information and conforms to the encoding parameters. The processes for pre-generating indexing information and for adjusting the encoded media data units will be discussed in detail later.

### Live Streaming Using a Pre-Indexed File Formats

A pre-indexed media file generated as above described can be used in live streaming applications, since indexing information of all media data units has already been obtained before the media date units are encoded. In this case, with known indexing information of all media data unit, a media data unit can be retrieved, decoded and playback upon being received, without waiting for the encoding of the whole media file. Hereinafter, a method for live streaming using a pre-indexed media file format according to the present application will be discussed.

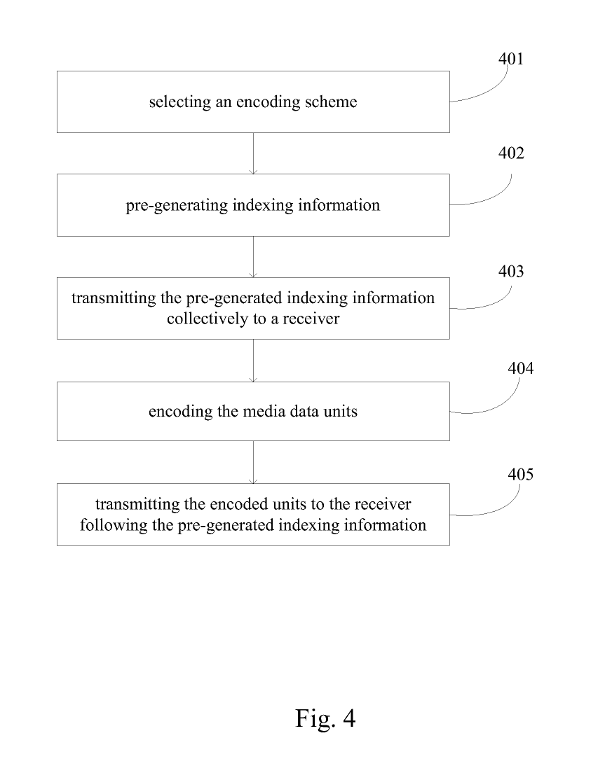

An illustrated chart flow of the method for live streaming a media file based on pre-indexing technique according to the present application is shown in FIG. 4. At step 401, an encoding scheme is selected for a media file. The encoding scheme may be selected based on pre-determined configuration, dynamically determined configuration, of which the exact method is application dependent. When the encoding scheme is selected, encoding parameters and an encoder profile are determined. The encoding parameters may comprise at least a frame rate and a bit-rate to be used for encoding. The encoder profile may specify an encoder-specific rule to be applied, such as an encoder pattern of intra-coded frames (I-frames), predicted frames (P-frames) and bi-predictive frames (B-frames). In one example, only I-frames are involved in the encoder. Alternatively, both I-frames and P-frames may be contained in the encoder according to a certain arrangement. Alternatively, I-frames, P-frames and B-frames may be contained in the encoder according to a certain arrangement.

At step 402, indexing information for all raw media data units to be live streamed is pre-generated based on the determined encoding parameters and encoder profile. At step 403, the pre-generated indexing information for all the raw media data units may be wholly transmitted to a receiver, for example, following a file header for the media file. Alternatively, the pre-generated indexing information for all media data units may also be stored in a shared storage in a server, such as shared disk storage or a shared memory buffer, which can be accessed by a receiver, instead of transmitting to the receiver. After all the indexing information is generated, raw media data units contained in the media file are encoded at step 404 according to the selected encoding scheme and then transmitted to the receiver following the pre-generated indexing information at step 405. Optionally, a step for adjusting the encoded media data unit to match the pre-generated indexing information may be further comprised between the steps 404 and 405, so that each of the encoded media data units precisely matches the pre-generated indexing information and conforms to the encoding parameters. The processes for pre-generating indexing information and for adjusting the encoded media data units are similar to those used in the method for generating a pre-indexed media file described hereinabove, which will be discussed in detail later.

According to the process described above, the set of indexing information {xᵢ|i=0, 1, . . . N−1} of the media data units to be encoded are determined before all the media data units are completely encoded. The encoding and transmission of a live media file according to the present application is illustratively shown in FIG. 3. As shown, the indexing information {xᵢ|i=0, 1, . . . N−1} is generated in an encoding and streaming server and then transmitted via a network upfront even before media units are encoded. Together with the necessary media file header, the complete set of pre-generated indexing information is transmitted to the receiver so that a decoder at the receiver is initiated to prepare for decoding the subsequent incoming media units. After the indexing information is all generated, the server encodes the raw media data units according to the selected encoding scheme and the pre-generated indexing information and then transmits the encoded media data units to the receiver for decoding and playback. Thus, a media data unit can be playback at the receiver upon being received, since the indexing information of all units has been already obtained by the receiver. Therefore, to the playback device at the receiver, it is as if the whole media stream was completely encoded before streaming begins while in actuality the server encodes the live media stream while transmitting the encoded media data units.

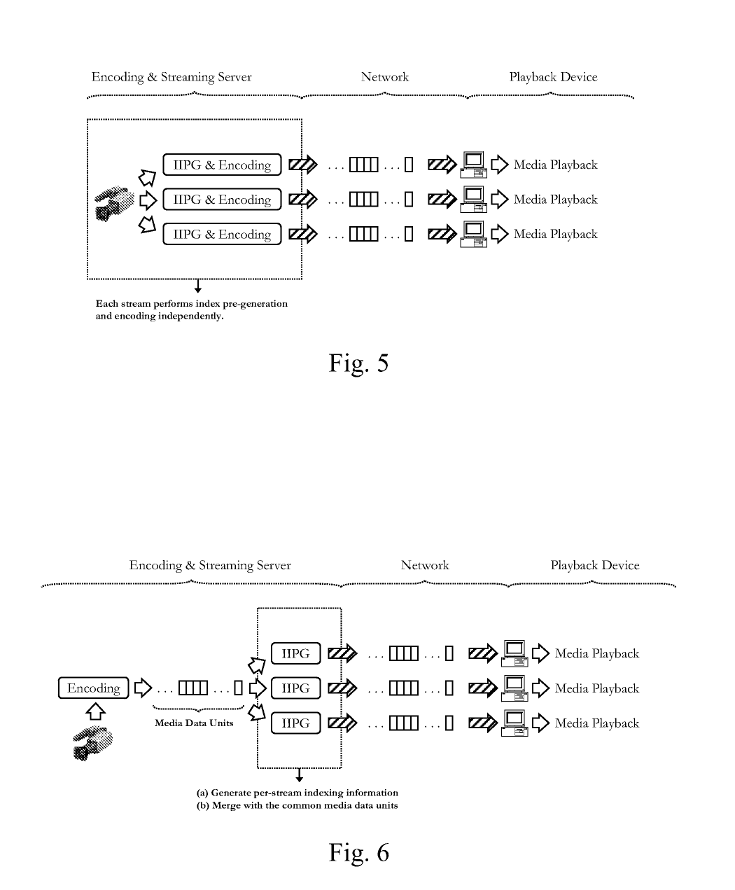

The method for live streaming media data units to one user using a pre-indexed file format has been described above. To live stream media data units to multiple concurrent users, multiple instances of the media encoding and Indexing information Pre-Generation processes may be implemented, with one for each individual stream as shown in FIG. 5. In this case, the raw media data units are copied for each of the multiple instances. Each copy then performs Indexing information Pre-Generation (IIPG) and encoding for one streaming session. However, for applications with a large number of users, a large amount of encoding processes are required, which is computationally expensive.

Therefore, a cascaded solution is proposed for applications with a larger number of users, as depicted in FIG. 6. In this solution, only one encoding process is employed to continuously encode the raw media data units into encoded media data units, irrespective of the number of active streaming sessions in the system. In particular, each streaming session had its own Indexing information Pre-Generation process which pre-generates the indexing information appropriate for the receiver's playback device configuration. That is, the indexing information is generated further based on configuration of the receiver. For example, one user may wish to generate an index for a playback duration of 30 minutes while another user may need to generate an index for a playback duration of 120 minutes. Then, the raw media data units are encoded and stored in a shared storage, such as shared disk storage or a shared memory buffer, in the server. Then, the encoded media data units' internal data may be adjusted if needed so that the encoded media data units may match the pre-generated indexing information. After pre-generated indexing information for a streaming session is transmitted to the corresponding user, the encoded (or further adjusted) media data units are transmitted to the receiver for decoding and playback. In this cascaded solution, the computationally-expensive encoding process only needs to be performed once irrespective of the number of current streaming sessions in the system. Therefore, this solution is more efficient and scalable.

In this case, for various streaming sessions associated with various users, size information of same encoded units contained in the indexing information is identical. However, other information, such as duration of the file and arrangement/order of the media data units, contained in the indexing information may be different for different users. The duration of the file may affect the size of the indexing information to be generated. By modulating the sequence of media data units based on the arrangement/order of the media data units, it is possible to create a pre-indexed media file unique to each user. This can be used for DRM or watermarking purposes. In addition, for different users, media data units may be encoded into multiple versions of video tracks and audio tracks, e.g., with different quality, different languages, etc. The configurations can be selected and combined dynamically upon connection setup.

The encoded media data units and possibly pre-generated indexing information are stored within the server. Upon accepting a new connection from a user, the system will use the stored contents and information to dynamically generate the pre-indexed media file for sending to the receiver. It should be understood that the generated media file does not need to exist as a physical file in the file system, but merely internally inside the system process's memory buffers. Neither does the system process need to buffer the whole generated file. Only the working portion, i.e., the portion being generated and transmitted, needs to be in memory.

Hereinafter, a detailed process for the step of pre-generating indexing information will be described in detail, which may be used in both the method for generating a pre-indexed media file and the method for live streaming such a pre-indexed media file.

For ease of description, it is assumed that N raw media data units denoted as {sᵢ|i=0, 1, . . . N−1} are contained in a raw media file, which are to be encoded into corresponding encoded media data units denoted as {dᵢ|i=0, 1, . . . N−1}. A set of indexing information of the encoded media data units is denoted as {xᵢ|i=0, 1, . . . N−1}. In this specification, the term “encoding” is used to refer to encoding, compression, or a combination of both.

Several embodiments for pre-generating indexing information are proposed in the present application. As stated above, the indexing information of each media data unit in a media file may include but not be limited to size, location and time information of the unit. Taking video encoding as an example, each media data unit may comprise one video frame. When a certain encoding scheme is selected, encoding parameters and an encoder profile are determined. The encoding parameters may comprise at least a frame rate of f frames per second and a bit-rate of r bits per second. The encoder profile may specify the pattern of intra-coded frames (I-frame), predicted frames (P-frames) and bi-predictive frames (B-frames), including size ratios of the different kinds of frames.

### Embodiment 1 for Pre-Generating Indexing Information

In a first embodiment for pre-generating indexing information according to the present application, the encoder profile specifies that only I-frames are used. In this case, the expected size x of each video frame is equal, which can be computed from:

x=(r/8)/f bytes

In this case, when an initial location l_{base} for the first frame to be playback is assigned, location l[i] (i=0, 1, . . . N−1) for each frame can be obtained by l[i]=ix+l_{base}. The location for each frame represents the physical address in which the frame is to be stored and retrieved. Similarly, when an initial time t_{base} for the first frame is determined, time for each frame can be obtained by t[i]=i×t_{δ}+t_{base}, since a duration t_{δ} of each frame is already known when a certain encoding scheme is determined. As an example, the duration may be computed from the inverse of the video frame rate, e.g., if the video frame rate is 10 fps then each frame may have a duration of 1/10 second. The initial location l_{base} may depend on the size of the pre-generated indexing information which in turn depends on the encoding profile, and the initial time t_{base} may depend on the encoding profile. The time for each frame represents the moment when the frame is going to be playback. Accordingly, indexing information including size, location and time of all frames are pre-generated before the frames are encoded.

After the above indexing information for all frames are generated, the video frames may be encoded into x-bytes frames at the frame rate f so that the subsequent encoded media data units will match exactly the pre-generated indexing information.

In one example, a particular encoding format, a variant of the Quicktime movie format (QT format for short), may be selected for illustration.

QT files are pre-indexed media files where indexing information of all media data units in the file is stored in a separate section of the file, typically near the end of the file. In this example, media files may be encoded into files in the form of a variant of the QT media file, in which the indexing information is stored near the beginning of the file, ahead of the media data units. As known, the QT file format organizes data and media information in objects called atoms. The complete file specification is available publicly with all standard atoms defined and described. In the context of the QT file format, indexing information of each media data unit may include, but is not limited to, the atoms as shown in Table 1.

TABLE 1
Examples of QT atoms included in the indexing information.

| Atom Type | Name |
|---|---|
| stco | chunk offset atoms |
| stsz | sample size atoms |
| stsc | sample-to-chunk atoms |
| stss | sync sample atoms |
| stts | time-to-sample atoms |

Details of these atoms are described in the QuickTime File Format Specification, which is entirely incorporated herein by reference. Common to these atoms is that a separate atom value is generated for each media data unit (called media data atoms in the QT context) in the file. In conventional encoding of QT media files, these atoms are generated as media data units are being encoded, and stored at the end of the QT media file after all media data units are completely encoded.

According to the embodiment of the present application, indexing information for all frames may be pre-generated and stored in a separate section in the beginning of the file following necessary file header immediately. As stated above, given a frame rate of f frames per second, a bit-rate of r bits per second, and an assumed I-frame only encoding profile, the expected size x of each video frame can be computed from:

x=(r/8)/f bytes

In the context of QT, the corresponding atoms can then be computed from the following equations in Table 2:

TABLE 2
relevant QT atoms to be pre-generated according to Embodiment 1

| | Computation | |
|---|---|---|
| Name | Methods | Notes |
| chunk offset atoms | stco[i] = | stco_{base}: initial offset for |
| | ix + stco_{base} | the first chunk offset atom. |
| sample size atoms | stsz[i] = x | All media data units have the |
| | | same size. |
| sample-to-chunk atoms | stsc[i] = 1 | One media data unit per chunk. |
| sync sample atoms | stss[i] = 1 | All media data units are I |
| | | frames. |
| time-to-sample atoms | stts = i × | stss_{base}: initial time base |
| | stss_{δ} + stss_{base} | for the first chunk. |
| | | stss_{δ}: duration of each |
| | | video frame. |

A number of other media file formats, including MPEG4 and 3GP, are based on the Quicktime file format. Thus, in these cases, indexing information could be computed similarly.

### Embodiment 2 for Pre-Generating Indexing Information

In the above mentioned first embodiment, it is assumed that raw media data units are encoded into encoded media data units perfectly matching the pre-generated indexing information. However, depending on the particular encoding method used, this may not always be practical. Thus, a second embodiment for pre-generating indexing information is proposed with a further parameter being incorporated.

In this embodiment, a new parameter called Overshoot Ratio, denoted by Y, is introduced, which specifies a ratio of the encoded media data unit size to the expected media data unit size. Specifically, the encoder will be configured to encode media data units with a target size of:

x=((r/8)/f)/Y bytes

In other words, the target size is reduced by a factor of Y. For example, with an Overshoot Ratio of Y=1.2, the target encoded media data unit size will be reduced by 20% compared to that corresponding to the original target bit-rate of r (or the encoding bit-rate will be reduced by 20%). With this mechanism, the encoder can encode a media data unit of size up to 20% larger than the expected size without overflowing the pre-generated media data unit size, thus allowing more flexibility to the implementation of the encoder. The value of Y may be selected based on specific encoding method and encoding parameters to be used. It may also depend on how the encoder is implemented. For example, if the encoder always produces media data units no larger than the prescribed size limit then Y can be set to 1.

After the target size x is thus determined, other indexing information such as location parameters and time parameters can be determined in a way similar to that described in the first embodiment.

In this case, depending on the specific encoder implementation, it is possible that the actual encoded media data unit has a size smaller than the pre-generated media data unit size. This will break the media file as the actual media data unit no longer matches the pre-generated indexing information. To overcome this problem, during the process of encoding, a technique called Media Data Unit Stuffing is further introduced to enlarge smaller media data units into the exact size specified in the pre-generated indexing information. Depending on the actual encoding method used, this can be done by (a) bit/byte stuffing; (b) adding user data into the media data unit; or other techniques available to the particular encoding method used.

For example, for audio media encoded using the AAC encoding method, a form of stuffing called fill element may be applied into the encoded media data unit. As for video media encoded using the MPEG4 simple profile encoding method, in order to enlarge the media data unit to the desired size, stuffing may be applied or user data may be introduced into the encoded media data unit.

Depending on the specific encoder implementation, it is also possible for the encoded media data unit to exceed the size specified in the pre-generated indexing information. This will also break the media file as the actual media data unit no longer matches the pre-generated indexing information. To overcome this problem, during the process of encoding, some data may be discarded from the encoded media data unit to make it fit. Depending on the encoder and decoder implementations, this may or may not result in visual degradation.

Finally, the choice of Y is user-configurable and should be optimized for the target encoding method and the set of encoding parameters used. In general, larger Overshoot Ratio results in fewer needs to discard data to make a media data unit fit the pre-generated indexing information, but at the same time increases the amount of data space wasted for stuffing/user data. As stated above, the value of Y depends on the implementation of the encoder and the encoding parameters used. For example, Y=1.15 may be used in AAC audio encoding and Y=1.1 may be used in H.264 encoding. By the introduction of the parameter Y, the encoded media data units can be more easily maintained within the size limit imposed by the pre-generated index.

### Embodiment 3 for Pre-Generating Indexing Information

The previous two embodiments consider media data units which are homogeneous, i.e., of the similar properties, since all frames are encoded into I-frames. This may not be the case in some encoder implementations. For example, in modern encoding methods such as MPEG, video frames are often encoded into three types of frames, namely I frames, P frames, and B frames. These frames have different average sizes even at the same encoding bit-rate, with I-frames the largest, following by P-frames, and finally B-frames the smallest. Thus if a constant size is used in the pre-generated indexing information, the media data unit size will be allocated according to that of the I-frames, resulting in significant storage/bandwidth wastage when storing/transmitting P-frames and B-frames which are typically much smaller.

To tackle this problem, a third embodiment for pre-generating indexing information is proposed, in which a technique called Encoder Profile is introduced. In this embodiment, special non-homogenous, encoder-specific rules can be applied in pre-generating the indexing information. Taking MPEG encoder with I-frames and P-frames as an example, the Encoder Profile will contain two additional parameters, namely the GOP Size, denoted by G, and the I-P Frame Size Ratio, denoted by W. The GOP size specifies the pattern of I-frames and P-frames. A GOP size of 10 means an I-frame is followed exactly by 9 P-frames, and then the pattern repeats. The I-P Frame Size Ratio specifies the average ratio between the size of an I-frame and that of a P-frame. A ratio of 4 means an I-frame is on average 4 times the size of a P-frame.

With this particular Encoder Profile, the sizes of I and P frames to be used in the pre-generated indexing information can be computed from:

I_{size}=(G/f)×(r/8)/(1+(G−1)/W)

P_{size}=(G/f)×(r/8)/(W+(G−1))

After the sizes of I-frames and P-frames are determined by known encoding parameters and encoder profile, other indexing information such as location parameters and time parameters can be determined in a way similar to that described in the first embodiment.

Taking the QT files again as an example, the QT atoms can be computed from a new set of formulae:

TABLE 3
relevant QT atoms to be pre-generated according to Embodiment 3

| Name | Computation Methods | Notes |
|---|---|---|
| sample size atoms | If (i mod G = 0) then stsz[i] = I_{size} else stsz[i] = P_{size} | (i mod G) equals to 0 when i is divisible by G. |
| chunk offset atoms | $stco [ i ] = {\mathring{a}}_{j = 0}^{i - 1} stsz [ j ] + {stco}_{base}$ (i = 1, 2, . . . , N-1) stco[i] = stco_{base} (i = 0) | stco_{base} : initial offset for the first chunk offset atom |
| sample-to-chunk atoms | stsc[i] = 1 | One media data unit per chunk. |
| sync sample atoms | If (i mod G = 0) then stss[i] = 1 else stss[i] = 0 | For I-frames, stss[i] = 1, else 0. |
| time-to-sample atoms | stts = i × stss_{δ} + stss_{base} | stss_{base} : initial time base for the first chunk. stss [symbol] : duration of each video frame. |

### Embodiment 4 for Pre-Generating Indexing Information

In a fourth embodiment for pre-generating indexing information, the sizes of I-frames and P-frames may be computed from the following equations with the Overshoot Ratio Y described in the second embodiment being introduced:

I_{size}=(G/f)×(r/(Y×8))/(1+(G−1)/W)

P_{size}=(G/f)×(r/(Y×8))/(W+(G−1))

After the sizes of I-frames and P-frames are determined, other indexing information such as location parameters and time parameters can be determined in a way similar to that described in the first embodiment.

It should be noted that the Encoder Profile technique is very general and the above technique to incorporate the characteristics of MPEG frame size differences is just one example. As long as the property of the encoder is known a corresponding Encoder Profile can be created to control the pre-generation of the indexing information to match the encoder's characteristics. For another example, a media encoder may add certain stream header information in the first media data unit so that the first media data unit will be much larger in size than normal. Instead of configuring the media data unit size to this exceptional and one-off data unit we can create an Encoder Profile to specify a larger media data unit size for the first data unit and reapply the normal size for the rest of the media data units. This will significantly reduces wasted storage/bandwidth and at the same time avoid the likelihood of discarding important header information in the first media data unit.

The third and fourth embodiments are proposed based on a pattern of I-frames and P-frames including the size ratio of the I-frame and P-frame. With the known pattern, target size of each media data unit is determined according to encoding parameters and optionally the Overshoot Ratio Y. The same principle can be further applied when I-frames, P-frames and B-frames are all involved. When a pattern of the I-frames, P-frames and B-frames including size ratios thereof is known, target size of each kind of frames may be computed similar to the described embodiments and then other indexing information may also be calculated. Thus the specific process will not be repeated here.

Hereinabove, embodiments are provided in the case of video frame. The same principle and computation methods can also be applied to other media types such as audio using the appropriate encoding parameters (e.g., audio frame rate in place of video frame rate). The details are not repeated here.

### System for Efficient Live Streaming

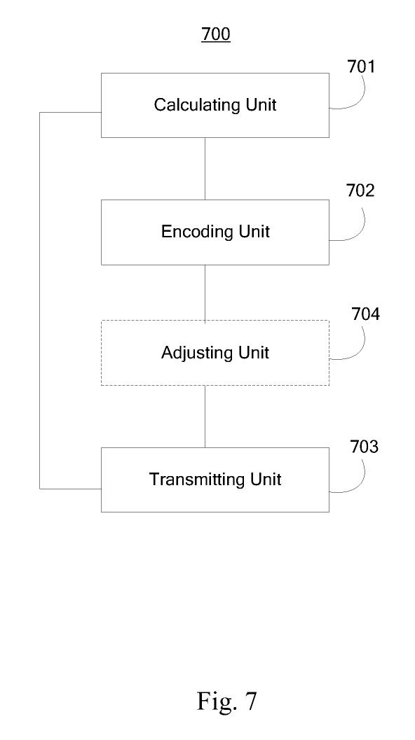

In the present application, a device for live streaming a raw media file based on pre-indexing is also provided. An illustrated device 700 is shown in FIG. 7. The device 700 comprises a calculating unit 701, an encoding unit 702 and a transmitting unit 703. The calculating unit 701 may calculate indexing information of all raw media data units contained in the raw media file based on encoding parameters, an encoder profile and configuration information of a receiver. The encoding unit 702 may encode the media data units sequentially according to the encoding parameters and the encoder profile. The transmitting unit 703 may transmit the indexing information of all the raw media data units and transmit a sequence of the encoded media data units to the receiver subsequently. Each of the encoded media units can be retrieved and decoded upon being received by the receiver based on the indexing information previously transmitted to the receiver.

The indexing information comprises size information, location information and time information for each of the raw media data units, the calculating unit calculates the size information from the encoding parameters and the encoder profile, and calculates the location information and the time information from the size information and the configuration information of the receiver. The encoding parameters comprise a frame rate and a bit-rate. The encoder profile comprises a pattern of I-frames, P-frames and B-frames including size ratios between each two of the I-frames, P-frames and B-frames. The configuration information comprises an initial location and an initial time for an encoded media data unit which is to be firstly retrieved decoded. The calculating units calculates the indexing information based on the encoding parameters, the encoder profile, the configuration information of a receiver and an overshoot ratio, wherein the overshoot ratio is specific encoder to be used.

The device 700 may further comprise an adjusting unit 704 for adjusting the encoded media data units to match the pre-generated indexing information before the encoded media data units are transmitted. The adjusting unit may stuff a first encoded media data unit to match a target size for the first encoded data unit specified in the pre-generated indexing information when the first encoded media data unit is smaller than its corresponding target size. The adjusting unit may discard data form a second encode media data unit to match a target size for the second encoded media data unit specified in the pre-generated indexing information when the second encoded media data unit is larger than its corresponding target size.

In an embodiment, the calculating unit 701 calculates a plurality sets of indexing information of all raw media data units contained in the raw media file for the plurality of receivers based on encoding parameters, an encoder profile and configuration information of the plurality of receivers. In this embodiment, the transmitting unit 703 may transmit each of the plurality sets of indexing information of all the raw media data units to its corresponding receiver and then transmit a sequence of the encoded media data units to the plurality of receivers in parallel.

The present application is not limited to the embodiments mentioned above. Other embodiments obtained by the skilled in the art according to the technical solutions in the present application should be within the scope of the technical innovation of the present application.

1. A method for live streaming a plurality of media data units using a pre-indexed media file format, the method comprising:
pre-generating indexing information of each of the media data units;
encoding each of the media data units;
transmitting the pre-generated indexing information to a receiver; and
transmitting a sequence of the encoded media data units to the receiver after the transmission of the indexing information.

2. The method of claim 1, wherein the pre-generating of the indexing information is based on encoding parameters and an encoder profile determined by a selected encoding scheme.

3. The method of claim 2, wherein the encoding parameters comprise a frame rate and a bit-rate used for the encoding.

4. The method of claim 2, wherein the encoder profile comprises a pattern of I-frames, P-frames and B-frames including size ratios between each two of the I-frames, P-frames and B-frames.

5. The method of claim 2, wherein the pre-generating of the indexing information is further based on configuration information associated with the receiver.

6. The method of claim 2, wherein the indexing information comprises size information, location information and time information for each of media data units to be encoded,
wherein the size information is calculated from the encoding parameters and the encoder profile, the location information, and
wherein the time information is calculated from the size information and the configuration information of the receiver.

7. The method of claim 2, wherein the pre-generation of the indexing information is further based on an overshoot ratio determined by an encoder to be used.

8. The method of claim 1, further comprising:
adjusting each of the encoded media data units to match corresponding indexing information before the step of transmitting the encoded media data units.

9. The method of claim 8, wherein the adjusting further comprises:
stuffing a first type of encoded media data unit in the encoded media data units to match a target size for the first type of encoded data unit specified in the indexing information, wherein the first type of encoded media data unit is smaller than the target size for the first type of encoded data unit specified in the corresponding indexing information; and
discarding data from a second type of encoded media data unit in the encoded media data units to match a target size for the second type of encoded media data unit specified in corresponding indexing information, wherein the second type of encoded media data unit is larger than the target size for the second type of encoded data unit specified in the corresponding indexing information.

10. A method for live streaming a plurality of media data units using a pre-indexed media file format to a plurality of receivers, the method comprising:
pre-generating a set of indexing information for each of the receivers, respectively, each set of indexing information including indexing information of each of the media data units;
encoding each of the media data units;
transmitting a corresponding set of indexing information to each of the receivers; and
transmitting a sequence of the encoded media data units to each of the receivers after the transmission of the indexing information.

11. A device for live streaming a plurality of media data units using a pre-indexed media file format, the device comprising:
a processor configured to determine indexing information of each of the media data units;
an encoder configured to encode each of the media data units; and
a transmitter configured to transmit the calculated indexing information for all the media data units to a receiver and to transmit a sequence of the encoded media data units to the receiver after the transmission of the indexing information.

12. The device of claim 11, wherein the processor is configured to determine the indexing information based on encoding parameters and an encoder profile determined by a selected encoding scheme.

13. The device of claim 12, wherein the encoding parameters comprise a frame rate and a bit-rate used for the encoding.

14. The device of claim 12, wherein the encoder profile comprises a pattern of I-frames, P-frames and B-frames including size ratios between each two of the I-frames, P-frames and B-frames.

15. The device of claim 12, wherein the processor is configured to determine the indexing information further based on configuration information associated with the receiver.

16. The device of claim 12, wherein the indexing information comprises size information, location information and time information for each of the encoded media data units, wherein the size information is calculated from the encoding parameters and the encoder profile, the location information and the time information is calculated from the size information and the configuration information of the receiver.

17. The device of claim 12, wherein the processor is configured to determine the indexing information further based on an overshoot ratio.

18. The device of claim 11, wherein the processor is further configured to adjust each of the encoded media data units to match corresponding indexing information.

19. The device of claim 18, wherein the processor is configured to stuff a first type of encoded media data unit of the encoded media data units to match a target size for the first type of encoded data unit specified in the indexing information, wherein the first type of encoded media data unit is smaller than the target size for the first type of encoded data unit specified in the corresponding indexing information; and
the processor is configured to discard data from a second type of encode media data unit of the encoded media data units to match a target size for the second type of encoded media data unit specified in corresponding indexing information, wherein the second type of encoded media data unit is larger than the target size for the second type of encoded data unit specified in the corresponding indexing information.

20. The device of claim 11, wherein the processor is configured to determine a plurality of sets of indexing information for a plurality of receivers, wherein each set of indexing information is used for a corresponding receiver and includes indexing information of each of the media data units; and
the transmitter is configured to transmit a corresponding set of indexing information to each of the receivers and to transmit a sequence of the encoded media data units to each of the receivers after the transmission of the indexing information.

21. A method for generating a pre-indexed media file, wherein the media file includes a plurality of media data units, the method comprising:
pre-generating indexing information of each of the media data units;
encoding each of the media data units;
storing the pre-generated indexing information of all the media data units; and
storing a sequence of the encoded media data units following the stored indexing information.

22. The method of claim 21, wherein the pre-generation of the indexing information is based on encoding parameters and an encoder profile determined by a selected encoding scheme.

23. The method of claim 22, wherein the encoding parameters comprise a frame rate and a bit-rate used for the encoding.

24. The method of claim 22, wherein the encoder profile comprises a pattern of I-frames, P-frames and B-frames including size ratios between each two of the I-frames, P-frames and B-frames.

25. The method of claim 22, wherein the pre-generating of the indexing information is further based on configuration information associated with the receiver

26. The method of claim 22, wherein the indexing information comprises size information, location information and time information for each of the encoded media data units, wherein the size information is calculated from the encoding parameters and the encoder profile, the location information and the time information is calculated from the size information and the configuration information of the receiver.

27. The method of claim 22, wherein the pre-generation of the indexing information is further based on an overshoot ratio determined by an encoder to be used.

28. The method of claim 21, further comprising:
adjusting each of the encoded media data units to match corresponding indexing information before the step of transmitting the encoded media data units.

29. The method of claim 28, wherein the adjusting further comprises:
stuffing a first type of encoded media data unit in the encoded media data units to match a target size for the first type of encoded data unit specified in the indexing information, wherein the first type of encoded media data unit is smaller than the target size for the first type of encoded data unit specified in the corresponding indexing information; and
discarding data from a second type of encoded media data unit in the encoded media data units to match a target size for the second type of encoded media data unit specified in corresponding indexing information, wherein the second type of encoded media data unit is larger than the target size for the second type of encoded data unit specified in the corresponding indexing information.
